(19) United States
(12) Patent Application Publication
(10) Pub. No.: US 2010/0223177 A1
(43) Pub. Date: Sep. 2, 2010

(54) METHOD, SYSTEM AND FINANCIAL PRODUCT FOR TRANSFERRING SHARES THROUGH A PRIMARY ISSUER MARKET

(76) Inventor: Michael VASINKEVICH, New York, NY (US)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/713,921

(22) Filed: Feb. 26, 2010

Related U.S. Application Data
(60) Provisional application No. 61/156,354, filed on Feb. 27, 2009.

(51) Int. Cl. G06Q 40/00

(52) U.S. Cl. 705/37

(57) ABSTRACT

A system, method and financial product for raising capital by selling the securities especially shares of equity of a company and/or entity that is privately or publicly traded in a primary issuance market between registered issuers and registered investors.

### BACKGROUND OF THE INVENTION

1. Field of the Invention

The invention relates to a system, method, financial product and financial exchange for transferring shares of a company and/or business entity that is privately or publicly traded in a primary issuance market between registered issuers and registered investors.

2. Description of the Related Art

A company wishing to issue shares of equity or other securities for trading on a public market and/or for private trading (e.g., selling between two unaffiliated parties) typically obtains the services of an underwriter to sell the underlying securities. The underwriter plays an important role in the ability of a company to exchange its securities for capital. The underwriter is able to assess the value of the underlying shares of equity or other securities and thereby provide the company and/or issuer with a reliable estimate of the amount of capital that may raised through the sale of the shares and/or other securities. In addition, the underwriter plays a marketing role whereby the underwriter identifies and gathers investors who put up capital in exchange for shares and/or securities issued by the issuer.

The shares made available as part of a new issue and/or issue offering are often sold on a public exchange such as the New York Stock Exchange (NYSE) or NASDAQ. Shares and securities may also be sold on other exchanges such as regional exchanges, the American Stock Exchange (ASE) and/or international exchanges. The share sales of greatest value and number are typically carried out on leading exchanges such as the NYSE and NASDAQ.

Conventionally, in exchange for providing these services the underwriter obtains a fixed percentage of the total value of the share and/or security issue as a fee. The underwriter's fee may vary depending on the size of the issue (i.e., the transaction involving the sale of shares of equity and/or other securities), the complexity of the issue, and the difficulty of identifying investors willing to risk capital for the purchase of the newly issued shares and/or securities. For well-established companies having a long track record of reliable and profitable performance an underwriting fee is typically in the range of 2-10% of the total value of the issue. The underwriter's fee may be substantially higher for companies undertaking their first issuance of shares, e.g., an initial public offering (IPO), or companies having shares that are not liquid and/or for which only a small market exists.

Most companies have recurring capital needs. Such needs derive from opportunities for investment such as expansion of existing businesses or the acquisition of businesses which may be integrated into a company's existing business. The issuance of new shares and/or securities to raise capital requires a substantial investment of time and resources for a company. A prospective issuer (e.g., company) must first reach a decision internally whether an issuance is in the best interest of the company and its shareholders. This often involves much discussion and debate at the highest levels of authority and management. Other stakeholders such as existing shareholders often have a voice in the decision whether a share issuance is in the best interest of both the company and the shareholders. Because of such difficulties and cost, some companies issue new shares only in limited circumstances such as for major acquisitions.

New share issuances are subject to regulatory review by government officials such as the Securities and Exchange Commission (SEC) in the United States. The SEC is charged with regulating the market for share issuances in a manner such that investors are provided with sufficient information from which to make an informed decision whether a particular share issuance is in the investor's best interest. An important determinant taken into account by regulatory bodies when judging the viability of an issuer's application for selling shares is whether the prospective issuer has issued shares in the past. The prospective issuer's overall reputation and public image also play a role.

In the United States the SEC classifies certain issuers as “well-known seasoned issuers” (WKSIs). Such companies typically have a history of prior share issuances and a diverse group of shareholders who hold a substantial amount of shares through affiliated parties. A WKSI may obtain an open registration from the SEC to issue a limited amount of shares on an open-ended basis. Such shares are typically sold in large blocks to large investors through an underwriting network.

The shares of a publicly traded company that are to be offered in a subsequent sale are known as secondary issuances. Such issuances are oftened burdened by transaction costs such as underwriting fees and/or discounts negotiated by the purchasers of large blocks of the shares.

Under certain circumstances an issuer may carry out the sale of new shares under a lightened regulatory load. For example, an issuer offering, for example, non-convertible preferred stock or debt that is rated investment grade may not be required to make a special filing with a regulatory body such as the NASD (National Association of Securities Dealers). Shares and/or securities already listed on a SEC Form S-3 may also be exempted from the NASD requirements for new share sales under certain circumstances. Nonetheless because the issuer may be subjected to regulatory overview by other bodies in addition to the NASD and/or SEC, the ability of an issuer to freely sell new shares to raise capital is complicated and thus often requires the services of an underwriter, agent and/or broker in order to achieve a successful sale. Nonetheless, certain well-established corporations are able to carry out “shelf offerings” by which new shares may be sold to the public to raise capital for the corporation.

However, if an issuer were permitted by regulation to sell new shares directly in the public market such sales may exhibit a significant downward pressure on the price of the shares. This effect is expected to be magnified for sales of large amounts of shares. Issuers are therefore disinclined to take responsibility for the initial sales of new shares in a public market and instead rely on the services of an underwriter.

The method, exchange, financial product and system disclosed herein by the inventors provides a primary issuer market (PIM) by which secondary issuances of shares are sold directly from an issuer to an investor for an amount that is substantially equal to the market price for the shares in a public market at the time of any secondary issuance sale.

### SUMMARY OF THE INVENTION

It is an object of the invention to provide a method for issuing and selling shares of a publicly traded company on an exchange.

It is a further object of the invention to provide a method by which an issuer of shares of equity in a company sells such shares to investors without the services of an underwriter.

It is a further object of the invention to provide a method by which a publicly traded company can issue and sell new shares directly on an exchange.

It is a further object of the invention to provide a method by which a publicly traded company can issue new shares and sell such shares on a primary issuer market exchange at a price that is equivalent to or substantially equivalent to the value of already-issued shares concurrently trading on a national exchange.

It is a further object of the invention to provide a method by which a company may raise capital by selling any one of shares of equity, debt, securities and/or rights on a primary issuer market exchange.

It is a further object of the invention to provide a method by which a publicly traded company registers with a primary issuer market exchange that is different from a national exchange; issues new shares of equity; offers the newly issued shares of equity for sale on the primary issuer market exchange for purchase by one or more investors also registered on the exchange.

It is a further object of the invention to provide a primary issuer market exchange for matching sellers of newly issued shares of publicly traded companies with investors willing to purchase such shares at the market price of the shares available on one or more national exchanges.

It is a further object of the invention to provide a method for marketing new securities to a pool of register investors.

It is a further object of the invention to provide a method for marketing an initial public offering to a group of investors who are registered through a primary issuer market exchange.

It is a further object of the invention to provide an apparatus that includes means for carrying out any of the objects of the invention on a computer system and/or by computer implemented means.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows an environment in which an issuer and an investor interact to transfer shares for value on a primary issuer market exchange;

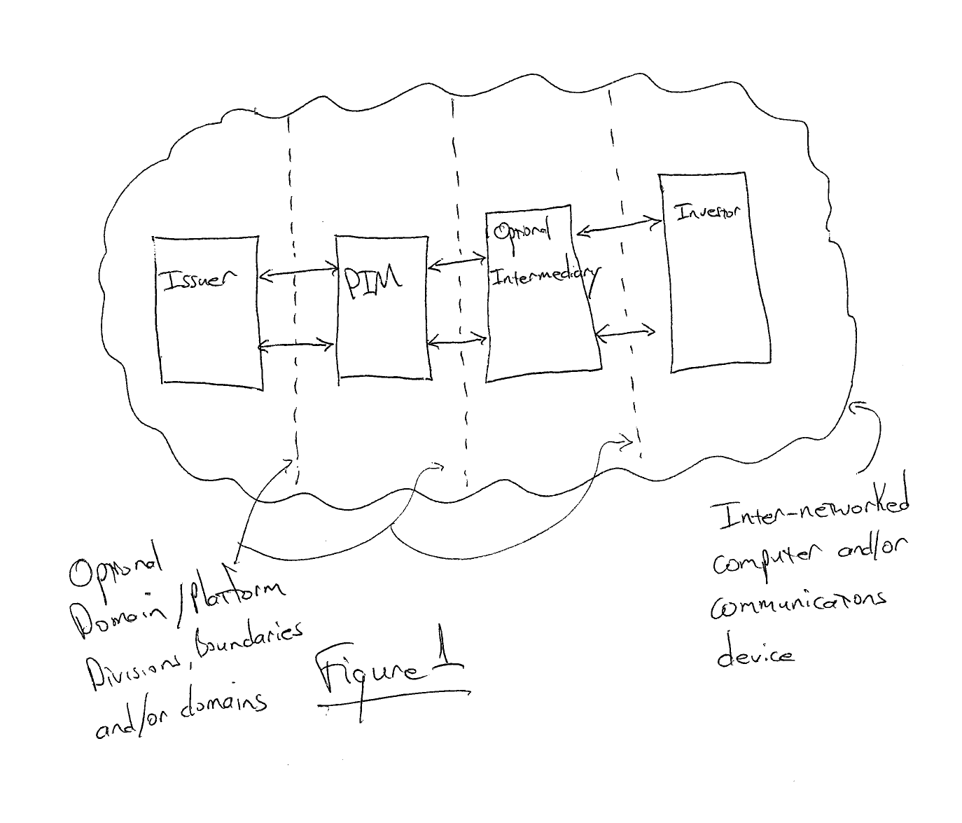

FIG. 2 illustrates a computer system on which one or more embodiments of the invention can be carried out.

### DETAILED DESCRIPTION OF THE INVENTION

In the context of the invention, a primary market is a market for newly issued securities. In a primary market securities such as shares of equity, debt obligations, and/or rights are transferred for value from an issuer to a first investor. A primary issuer market is a financial market that is a securities exchange on which newly issued shares of equity of a publicly traded corporation are sold to investors.

In the context of the invention, a secondary market is a market in which the securities of an issuer are sold between parties other than the issuer. Sales and/or transfers of shares of equity, debt obligations and/or rights of an issuer sold in the secondary market are sales occurring subsequent to the original issuance of the securities and/or shares. A secondary market is also known as an after market.

An exchange and/or a stock exchange is a financial market where securities such as shares of equity, debt (e.g., bonds and notes), and rights are sold between parties. A national exchange is one of the exchanges in the United States that includes the NYSE (New York Stock Exchange), NASDAQ (National Association of Securities Dealers Automated Quotations), and/or ASE (American Stock Exchange). An exchange functions by matching buyers and sellers in the manner by which sellers offer, for example, shares for sale at a price and/or purchasers offer certain value for securities. In the context of the invention, an exchange is a financial marketplace on which the shares, debt and/or rights of publicly traded corporations is traded between parties.

An offering is an offer by an owner of a security such as a share of equity, a debt obligation and/or a right, for the sale of a security. In the context of the invention, an offering is accompanied with any disclosures required by law and/or regulations such as the rules and regulations of the SEC. In the context of the invention, an offering is an offer for sale of a security put forth by a corporation offering newly issuing shares.

In a preferred embodiment of the invention an offering does not include the services of an underwriter. In a further preferred embodiment of the invention an offering includes marketing and registration requirements that address only the investors of a primary issuer market exchange that are registered with the exchange. In a preferred embodiment of the invention the method for selling newly issued shares does not include the services of a broker or agent. In another embodiment of the invention the method for selling newly issued shares includes the services of a broker or agent who is paid a fixed fee.

In the context of the invention, an investor is an individual, a party, a business entity such as a corporation or other legally recognized business entity of limited liability that is registered with a primary issuer market exchange. Investors may include individual investors who are members of the public. Investors may further include individuals identified as “high net worth” individuals meeting certain criteria such as having a minimum net worth of at least $1,000,000, a minimum individual income of at least $200,000 and the like. In the context of the invention an inventor includes accredited investors as defined by the SEC. In preferred embodiments of the invention investors include corporations and financial entities organized for the purpose of investing for profit on the behalf of one or more other parties, such as mutual funds, unit investment trusts (UIT), closed end funds, hedge funds, and the like.

In the context of the invention a publicly traded company is a corporation or company incorporated under the laws of one or more of the states of the United States of America. A publicly traded company is a company registered with an exchange such as one or more of the U.S. national exchanges for the purpose of raising capital by the sale of shares of equity on the exchange. A publicly traded company is subject to the laws and regulations of the SEC and the NASD with respect to sales of shares of equity on an exchange. In other embodiments of the invention a publicly traded company is one that is organized under the laws of a foreign country, e.g., a foreign company. A foreign company may be registered and offer for sales shares of equity and/or other securities on more than one market exchange including for example a U.S. national exchange, a international stock exchange (ISE) or other market in which shares of equity of the company are traded or sold.

The market price of a share of equity, a debt obligation and/or a right is the price at which buyers and sellers exchange the share of equity, debt obligation and/or right for good and valuable consideration in an open, regulated exchange. The market price of a security may vary over the course of time. During one day of trading the market price for a share of equity varies between an intraday high and an intraday low.

In one aspect of the invention, a corporation or company that is publicly traded on a national exchange in the United States raises capital by issuing new shares of equity. The corporation or company does not obtain any capital for the newly issued shares of equity until after the corporation has exchanged the newly issued shares for good and valuable consideration. Such good and valuable consideration is most often in the form of money which is given to the corporation in exchange for the shares of equity. A corporation may sell such newly issued shares of equity in different ways. In a preferred embodiment of the invention the corporation (“the primary issuer”) sells newly issued shares on an open exchange. Existing national exchanges such as the NYSE, ASE and NASDAQ are regulated by the U.S. government and regulated by one or more securities institutions in a manner that makes the sale of newly issued shares of a primary issuer subject to certain conditions. Such regulations and/or conditions preclude many prospective primary issuers from selling newly issued shares on one of the national exchanges. Nonetheless, certain primary issuers are able to obtain permission from regulatory bodies to undertake “shelf offerings” whereby shares of equity of the primary issuer are sold on an open exchange. Such shelf offerings are advantageous because they eliminate the need for a long or regulatory review prior to issuance of new shares. In one embodiment of the invention a primary issuer obtains regulatory approval to undertake a shelf offering. The size of the shelf offering may be defined both in the number of shares and the total values of the shares to be sold in the shelf offering. In a preferred embodiment of the invention the shelf offering is defined according to the number of shares to be newly issued.

In a preferred embodiment of the invention the new shares of equity of the primary issuer are sold at a price on an open exchange that is the same or substantially the same as the price for which previously registered and sold shares of equity having the same rights as the newly issued shares of equity are sold on a national exchange.

For example, on a particular day at a particular time shares of equity of a corporation XYZ corporation are sold on the NYSE at $12/share. The shares are common shares paying a dividend of, for example, from 0.01-10% annually. A share of common stock typically includes a single vote per share. The sale of shares on the national market occur in a dynamic manner in which purchasers and sellers are constantly meeting in the marketplace to exchange shares for value. The price for a share of XYZ corporation may vary during the day. When XYZ corporation sells newly issued shares on the primary issuer market the sales the primary issuer market are conducted at or near the price at which trading for previously-issued and registered shares of XYZ corporation are trading concurrently on the national exchange. Thus, if at a point in time shares of XYZ corporation are selling at $12/share, the price at which XYZ corporation offers newly issued shares for sale on the primary issuer market is at or near $12/share. In a preferable embodiment of the invention the issuer sells newly issued shares on the primary issuer market at a price that is equal to the “at the market” price of the national exchange. An “at the market” price is that price at which a purchaser wishing to purchase shares of a company on an open market places an order for immediate trade at the lowest present offering price of one or more sellers.

Preferably the proceeds of the sale of the newly issued shares of equity go entirely to the primary issuer. However, because certain fees such as an SEC settlement fee is assessed to shares sold on an open market, the primary issuer preferably receives at least 95%, more preferably at least 96%, 97%, 98%, 99%, 99.5%, 99.9% of the proceeds of the sale of newly issued shares in the primary issuer market. Preferably the issuer receives 100% of the sale price of the shares of equity after any exchange and/or regulatory fees are settled.

In one embodiment of the invention the primary issuer offers newly issued shares for sale on the primary issuer market to a broker or transfer agent. The broker or transfer agent may assess a fee such as 0.5%, 1%, 1.5%, 2%, 2.5%, 3%, 3.5%, 4%, 4.5%, and/or 5% of the total value of the shares for carrying out one or more functions such as maintaining a liquid market, acting as an agent to record the sale, and/or carrying out marketing to identify an investor to purchase the newly issued shares.

The primary issuers listed on the primary issuer market are registered on the exchange. The registration necessary in order to participate in a primary issuer market is less onerous than the registration necessary to obtain a listing on a national exchange. In one embodiment of the invention, a listing on a national exchange is a prerequisite for listing on a primary issuer market exchange.

Because registration on a national exchange must include compliance with applicable regional and national regulations, in one embodiment of the invention, registration includes providing the number of newly issued shares to be sold, the price range at which the newly issued shares are expected to be sold, the time period during which the newly issued shares are expected to be sold, the recordation of the primary issuer, and the like. Preferably, registration on a primary issuer market is a matter of form not subject to regulatory review other than that regulatory review otherwise required for listing on a national exchange and/or required for registering an offering such as shelf offering.

Once registered on a primary issuer market exchange, the market price identified for the securities of a particular primary issuer is substantially the same as the market price provided on an open national exchange. It is thus not necessary to use recent buy/sell data obtained directly from the primary issuer market in order to obtain the market price for particular shares on the primary issuer market. Even where no newly issued shares have been sold for periods of hours, days, weeks, months or years, a primary issuer immediately knows the market price for newly issued shares based upon the market price for shares of equity exchanged on a national exchange.

This aspect of the invention provides a substantial advantage for the primary issuer. In times of market distress or low share prices, a primary issuer is not obligated to make newly issued shares available for sale. The primary issuer may wait until the market price for its shares on an open national exchange are within a target range before undertaking sales on a primary issuer market. This provides a further benefit to the primary issuer by avoiding flooding the open national market with newly issued shares and thereby depressing the market price. By carrying out the invention in this manner the primary issuer acts in the capacity of a market maker matching its supply of newly issued shares with willing buyers.

The primary issuer market is preferably an electronic market that inter-networks buyers and sellers. Such a marketplace is similar to the markets used for the national exchanges and/or international exchanges such as ISE. In one embodiment of the invention the purchase and sale of shares is carried out by a national exchange as part of a market segregated from the national exchanges normal buying and selling routine.

In one embodiment of the invention any publicly traded company in the world may utilize the primary issuer market as a marketplace for securities and/or shares. Preferably, such shares are registered shares that are freely tradable after their initial purchase on the primary issuer market.

A primary issuer may sell newly issued shares in different forms. For example, a primary issuer may sell newly issued shares in the form of blocks such as large number of shares. Such blocks may comprise 1,000, 5,000, 10,000, 20,000, 30,000, 40,000, 50,000, 60,000, 70,000, 80,000, 90,000, or 100,000 shares of newly issued equity or any multiple or fraction of the aforementioned blocks of shares. The sales of large blocks of shares are preferably carried out with one or more types of investor having the resources to immediately settle such trades for cash. For example, large blocks of newly issued shares may be carried out on a primary issuer market exchange by selling such shares to an investment entity such as an insurance company, a mutual fund, a hedge fund and/or a retirement fund and the like. The primary issuer may carry out block sales of newly issued shares on a regular or irregular basis depending on the market conditions and the primary issuer's need for new capital.

In another embodiment of the invention the primary issuer sells sufficient numbers of newly issued shares to meet the demand for such shares on the primary issuer market. For example, the primary issuer market exchange may register any number of small or individual investors willing to purchase non-block and/or odd-lot groups of shares. Because the price of newly issued shares is always reflected in the market price of previously issued shares available on a public, open national exchange, a registered investor simply places an order to buy a certain number of shares on the primary issuer market exchange and the primary issuer matches the investor's order with the desired number of shares at the concurrently prevailing market price of the public, open national exchange. Settlement between investor and primary issuer may occur directly between the issuer and the investor or such sales may be settled through a third party servicer.

In one embodiment of the invention a corporation publicly traded on a national exchange obtains regulatory approval to carry out a continuous offering of shares of equity in the form of common stock, preferred stock and/or special stock, and/or warrants (e.g., a shelf offering). A corporation carrying out a continuous offering such as an offering for common stock may sell shares of the common stock from time to time on a national exchange as opportunity permits. The corporation undertaking the continuous offering may sell its shares when conditions are advantageous to the issuer. For example, the issuer may sell all or a portion of its shares at a time when the share price is high or at a time when the corporation needs a capital infusion. Alternately, the corporation may carry out regular and/or periodic sales of its shares as a part of the continuous offering.

One example of a continuous offering is the continuous offering described in the Form S-3 for Delta Airlines, Inc. filed with the SEC on Dec. 17, 2008. The Delta Airlines Inc. Form S-3 filed with the SEC on Dec. 17, 2008 is incorporated herein by reference in its entirety. In this continuous offering the issuer, Delta Airlines, carried out a continuous offering under a distribution agreement with Citigroup Global Markets Inc. who acted as a sales agent for the sale of the shares into the NYSE. The sales agent for this continuous offering obtained a commission equal to 2% of the sales price per share of shares sold in the continuous offering. Any of the aspects of the Delta airlines continuous offering may be incorporated in the process, financial product and/or system described herein.

In the invention described herein, a continuous offering similar or the same as the Delta continuous offering is undertaken, however, a sales agent is not needed thereby increasing the issuer's yield (e.g., total capital raise) and further the newly issued shares are sold on a primary issuer market exchange, not an open public national exchange. In other embodiments of the invention a sales agent and/or broker may be used to facilitate the sale and or transfer of the newly issued shares but such sales agent and/or broker obtains no more than a conventional fee for carrying out sales/tranfers of shares in the continuous offering. In a further preferred embodiment of the invention a continuous offering is carried out in the same manner described in the Delta Form S-3 in a manner such that the issuer sells newly issued shares on a primary issuer marker exchange and subsequently obtains payment for shares directly from the investor, i.e., the investor makes a direct cash transfer to the issuer without use of any intermediary.

Another example of a continuous offering program by which an issuer carries out periodic sales of common stock, preferred stock, warrants, rights and/or securities by selling such securities into a national market from time to time at the prevailing market price is described in the continuous offering program agreement of Rodman & Renshaw LLC (the Rodman Continuous Offering). The Rodman Continuous Offering agreement is incorporated herein by reference in its entirety. Under the details of the Rodman Continuous Offering an agent or intermediary may collect a fee for carrying out sales and marketing of securities. In one embodiment of the invention a continuous offering is carried out according to any of the details and/or methods described in the Rodman Continuous Offering, however, the continuous offering is carried out without an intermediary or sales agent and exchange of the issuer's securities with an investor occurs by direct settlement between the investor and the issuer. Thus, an investor makes payment directly to an issuer. In other embodiments of the invention one or more brokers or sales agents may be used to market and/or sell the securities made available for sale on the continuous offering, however, at a substantially reduced commission that is no more than the conventional commission charged for carrying out a sale of securities between two unrelated parties.

Further embodiments and advantages of aspects of the invention are described in the Rodman & Renshaw “At-The-Market Offering Program” circular incorporated herein by reference in its entirety.

Once established, a primary issuer market will provide a community, network and/or environment of investors having an appetite for the shares of common stock of publicly traded companies. The investors may range in size from small investors such as individual investors to investment groups and/or business entities such as mutual funds and hedge funds. This group of primary issuer market investors will have the resources to participate in other investment products/schemes. The primary issuer market may therefore function as a means by which other investments are marketed and/or offered for sale to a group of qualified investors. Advantages in using the primary issuer market for this purpose include the primary issuers' ability to quickly access a group of potential investors, already be vetted by registration through the primary issuer market and having the resources to invest in the securities offered by the primary issuers registered with the primary issuer market.

For example, a primary issuer market may attract a large number of users and/or investors wishing to invest funds in exchange for securities such as common stock, preferred stock, debt, and/or other financial products. Investors find the convenience of the primary issuer market exchange desirable and return to the primary issuer market on a regular basis to check for investments which may qualify for or meet the investment profile of the investor. In one embodiment of the invention the primary issuer market includes a group of returning investors who monitor the primary issuer market exchange for offerings and/or investment opportunities. In this embodiment the primary issuer market functions as a clearinghouse and/or open exchange for any offering by a registered issuer. In this embodiment the primary issuer market caters to a class of investors specifically wishing to purchase primary offerings, not only investors interested in the offerings of a particular issuer.

In addition to the option of purchasing shares in companies that are already publicly traded, an investor may further have access to investment information regarding new share issues such as initial public offerings (IPO). An IPO is a primary offering of securities such as common stock by a company that otherwise does not have a secondary market for such securities.

In the primary issuer market registered investors wishing to take part in an IPO may receive marketing materials such as the information typically provided to perspective investors during a “road show” of a new offering. Marketing materials received by any particular primary issuer market registrant may be tailored for that investor's primary issuer market profile. Marketing information provided to the investor includes the necessary regulatory disclosures, and, in addition, market reports and/or other information which may be of use to an investor studying the prospects of a company carrying out an IPO.

In one embodiment the primary issuer market registrants are able to contact one another and exchange comments with respect to any offering made on the primary issuer market exchange. In a more preferred embodiment of the invention the primary issuer market registrants do not use the primary issuer market exchange as a forum for the exchange of communication regarding offerings. In this aspect the primary issuer market community is one in which the primary issuer market pushes information to the investors which are in effect isolated from one another in the primary issuer market network.

In another embodiment a primary issuer market registrant can search a database accessible through the primary issuer market exchange describing upcoming IPOs and/or other investment offerings. In addition, or separately, the database may include forthcoming issues and/or offerings, and, may provide an archive of transactions previously carried out. Information may be organized by any descriptor, qualifier, or classification of interest to an investor. For example, in an embodiment of the invention an investor may search on SIC code in order to identify any company in a particular industry carrying out a secondary offering and/or an IPO. Likewise, an investor may carry out a search of the primary issuer market database to find particular investment products of interest to the investor, such as convertible securities, warrants, common stock and the like. This searching functionality provides a means by which a primary issuer market user, i.e., a registrant on the primary issuer market exchange, can utilize the primary issuer market exchange on an ongoing basis for investment purposes.

In other embodiments, the primary issuer market exchange, or a similar exchange separate from the primary issuer market exchange but dedicated to collecting and organizing information regarding initial public offerings, can include a searchable database that includes automated methods of identifying and informing investors of upcoming offerings.

A prospective investor may quickly access information regarding any IPO and/or offering of a publicly traded company and/or a company registered to undertake an IPO. Information describing the company and/or the security offering may include an investor report describing the technical and/or legal aspects of an investment; the market in which the company is operating; and third party reports describing and/or analyzing the performance prospects of the company.

Legal reports describing the legal and/or regulatory aspects of an offering may also be made available to investors. Any agent participating in the offering may likewise prepare a report and make such report available to the user of the primary issuer market and/or the registrant. Investment advisors may also play a role in pointing investors to particular investments through the investment advisors' registration on a primary issuer market and/or an IPO-based system.

In one embodiment of the invention the issuer and investors are connected to the PIM through a communications or electronic network. The issuer may obtain information regarding the market conditions for the sales of a new issue offered on the primary issuer market exchange (e.g., sales of new shares of equity). This information may include real time, current and/or historical pricing and volume statistics. The issuer may have access to at least all of the information obtainable through a Bloomberg screen or any other public, proprietary and/or conventional screen trading system.

In addition the issuer may have access to a list of the investors that are registered with the primary issuer market exchange. For example the issuer may have information that identifies the investor by category, e.g., private investor, hedge fund, UIT, and the like along with information showing the investor's prior activity on the primary issuer market exchange. This information may provide a way for the issuer to determine the financial capabilities of the investor and/or the investors risk threshold.

The issuer may access this information through a screen or dashboard which displays the information in an interactive manner. For example the issuer may view the information on a screen that is linked to a plurality of databases through virtual buttons and/or tabs. The issuer may click on a tab or link to thereby access information organized on the screen and/or dashboard (the party placing a bid may have access to a like screen trading system to obtain information describing the issuer and/or the offering). The information is then retrieved from one or more electronic storage systems (i.e., a database such as an Oracle database containing publicly available or proprietary information) and presented through images shown on a screen such as the screen of a desktop computer device, screen device, mobile device or any conventional communications interface device.

In one preferred embodiment of the invention the sale newly issued shares of equity and/or other security is carried out in an ask/bid environment. For example, the current market price for existing shares of a company trading on a public exchange may be $10 (for example: bid $9.95/share; ask $10.05 share; last execution/sale $10.00/share. Investors on the primary issuer market exchange may likewise bid on newly issued shares of equity. The investors may place bids for market execution or may place bids with any execution price. For example an investor may bid on any amount of shares (so long as the amount of shares is equal to or less than the total number of shares available in the offering) by offering an amount on a per share basis or on a block basis.

In this embodiment of the invention the investor's bid to buy newly issued shares of equity is communicated through the primary issuer market exchange to the issuer. The issuer may determine the identity of the investor. As described above the issuer may obtain specialized information describing the financial characteristics of the investor such as the investor's prior bidding and/or purchase activity on the primary issuer market exchange. The issuer can further obtain information such as third party reports describing the financial condition of the investor and the investor's proven line of credit and/or cash resources.

The issuer may also contact the investor and/or party placing the bid for the newly issued shares through the primary issuer marker exchange's communications network. For example the issuer may send the party placing a bid on newly issued shares of equity an electronic communication such as an email, text message or any other form of encrypted or non-encrypted message acknowledging the bid. A preferred method includes contacting eh party placing the bid directly through the primary issuer market exchange's screen/dashboard interface. Thus, the issuer may directly and immediately respond to a bid for the issuer's newly issued shares of equity or other security. The issuer can also contact the party placing the bid through a conventional communication channel that is separate from the primary issuer market exchange such as by telephone.

In this embodiment of the invention the issuer may respond to a bid at conditions outside the market price. For example, the issuer may determine that a block sale of new issued shares is in the issuer's best interests (e.g., if the bid price is higher or lower than the current market price on either a national exchange or the primary issuer market exchange). After a bidder places a bid for the block of shares or at a particular execution price the issuer may determine whether to accept the bid. The issuer may make this determination with or without taking into consideration the current market price for the newly issued shares and/or the current market price of already issued shares on a public exchange such as a national international exchange. For example, the market conditions on a public exchange are $9.90/share bid; $10.00/share ask; last sale@$9.95/share; the market conditions on the primary issuer market exchange are $9.95/share bid; $10.00/share ask; last sale@$10.00/share; the issuer receives a bid through the primary issuer market exchange of $9.50/share for 50% of the total number of shares available in the offering (e.g., a block trade). The issuer may accept the bid, decline the bid, or contact the bidder with a counter offer or invitation to negotiate.

The issuer may engage in a continuing dialog with the investor. For example, the issuer may send the bidder information through the primary issuer market exchange relating to the financial prospects of the issuer. This information may include the registration materials filed by the issuer with a regulatory agency such as the SEC and/or may include specialized information such as videos and or proprietary financial analysis and/or reports. In some instances this information may be the property of the primary issuer market exchange and may be available only through the primary issuer market exchange's communications network/environment/community. In this embodiment of the invention the primary issuer market exchange functions as a portal through which enables the sale and marketing of the issuer's offering.

In this embodiment the bidder is provided with an efficient means to obtain specialized pricing and/or sales conditions for the newly issued securities. The bidder is also provided with a direct and private access and/or a negotiations channel to the issuer from which to affect the conditions of purchase of the securities.

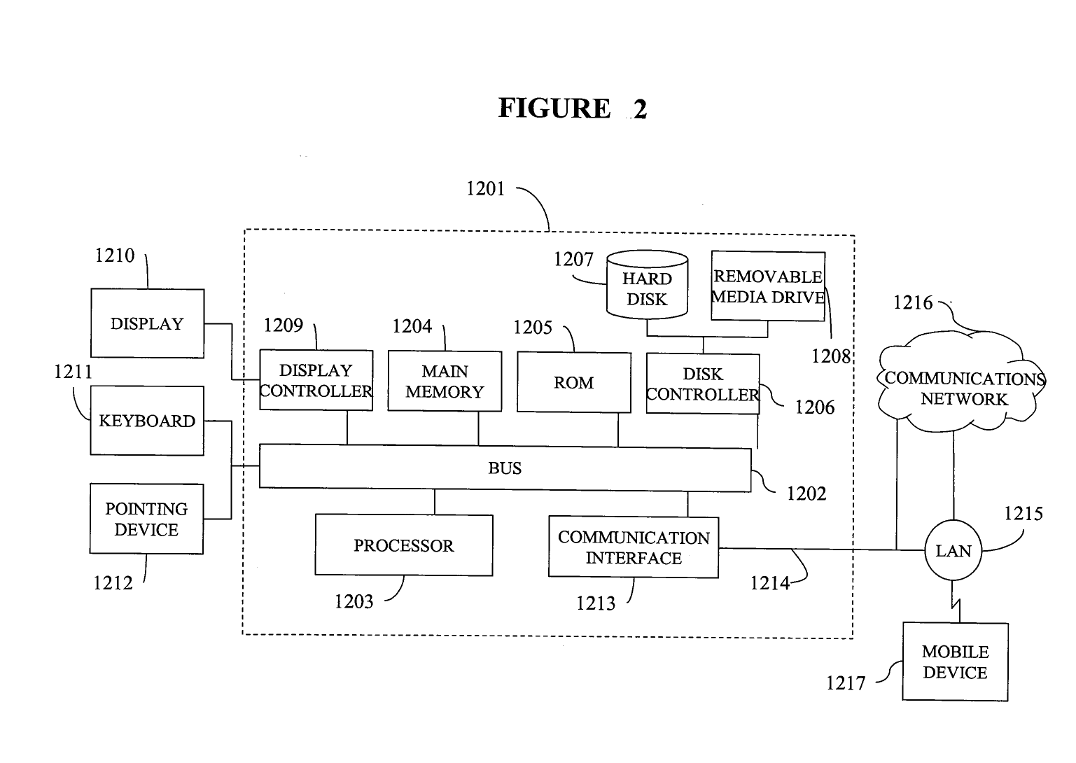

FIG. 2 illustrates a computer system 1201 upon which an embodiment of the present invention may be implemented. The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as a cathode ray tube (CRT), for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the invention in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1203 for execution. A computer readable medium may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

1: A method for raising capital by selling one or more securities of a publicly traded company, comprising:
an issuer selling the securities to an investor on a primary issuer market;
wherein the issuer is a publicly traded company having a shelf offering registered with the NASD;
wherein both the issuer and the investor are registered participants of the primary issuer market;
wherein the securities are offered for sale to one or more registered inventors at a price that is the same as the market price of the shares offered on the NYSE, NASDAQ; ASE or a foreign exchange;
wherein the selling is conducted electronically on the primary issuer market on a computer networked with one or more computers and one or more communication devices.

2: The method of claim 1, wherein the issuer is a well known seasoned issuer according to Rule 405 as amended and adopted by the SEC in 2005.

3: The method of claim 1, wherein the issuer sells the securities directly to the investor.

4: The method of claim 3, wherein the securities include one or more of shares of equity, debt and rights.

5: The method of claim 1, wherein the issuer sells the securities to the investor through a broker.

6: The method of claim 1, wherein the issuer sells common stock to the investor at a selling price that is the same as the market price of the common stock on an open market selected from the group consisting of the NYSE, NASDAQ and the ASE, at the time of the sale to the investor; and
wherein the issuer obtains at least 98% of the proceeds of the sale of the common stock, wherein the proceeds of the sale is the value of the common stock on the open market at the time of the sale of the common stock to the investor.

7: The method of claim 1, wherein the issuer sells the shares to the investor through a transfer agent.

8: The method of claim 1, wherein the issuer sells shares to the investor by subscription.

9: The method of claim 1, wherein the securities are shares of common stock registered in a shelf offering.
